(19) United States
(12) Patent Application Publication
(10) Pub. No.: US 2018/0005314 A1
(43) Pub. Date: Jan. 4, 2018

(54) OPTIMIZATION OF BID PRICES AND BUDGET ALLOCATION FOR AD CAMPAIGNS

(71) Applicant: International Business Machines Corporation, Armonk, NY (US)

(72) Inventors: Ying Li, Mohegan Lake, NY (US); Pietro Mazzoleni, New York City, NY (US); Pavankumar Murali, Elmsford, NY (US); Anshul Sheopuri, Teaneck, NJ (US); Roman Vaculin, Bronxville, NY (US)

(21) Appl. No.: 15/197,964

(22) Filed: Jun. 30, 2016

(51) Int. Cl. G06Q 30/08; G06Q 30/02

(52) U.S. Cl. CPC G06Q 30/08; G06Q 30/0277; G06Q 30/0244; G06Q 30/0246

(57) ABSTRACT

Aspects of the present invention include a method, system and computer program product. The method includes determining, by the processor, an optimal bid price for each one of a plurality of campaigns in each one of a plurality of online real time bidding auctions. The method also includes determining, by the processor, a winning function for bids placed for campaigns in each one of a plurality of online real time bidding auctions, and determining, by the processor, a bidding function for bids placed for campaigns in each one of a plurality of online real time bidding auctions. The method also includes determining, by the processor, the optimal bid price for each one of a plurality of campaigns in each one of a plurality of online real time bidding auctions as a function of the determined winning function and the determined bidding function.

### BACKGROUND

The present invention relates to buying and selling of online Web page advertising in real time bidding environments, and more specifically, to methods, systems and computer program products that optimize bid prices and budget allocation for online Web page advertising spending campaigns in real time bidding environments.

In the field of programmatic or real time bidding (“RTB”) in auctions rapidly taking place automatically for placement of online advertising on Web pages of the Internet, it is known for a buyer of advertisements or ads (i.e., the advertiser or marketer of products and/or services) to determine both the “optimal” bid price (i.e., the dollar amount) for an ad or “impression” to be placed on a publisher's Web page and the budget allocation for an advertising campaign using various different criteria. An “impression” typically means each time an ad is displayed on a Web page, but not necessarily clicked on by a viewer of that Web page. Also, “impressions” typically means the number of times that an ad has been displayed on one or more Web pages. Each auction typically lasts only less than a second before a Web page with a winning advertiser's ad located at a certain slot or spot on the Web page is loaded by a user on the Internet.

Oftentimes a relatively complex algorithm embodied in software running on a computer or processor utilizes the various different criteria (e.g., time of day, subject matter of publisher's Web page, demographics of the user starting to load the publisher's Web page on his/her computer, etc.) to rapidly determine both the optimal bid price for an ad as well as the ad budget allocation for a period of time (e.g., one hour) during the day. RTB typically results in the advertiser with the “winning” (i.e., the highest dollar amount) bid paying only for the impressions (i.e., the ads that will be displayed) that they want, and the publisher getting the best prices for those impressions. Although it should be noted that RTB is usually a “second price” type of auction where the bidder with the highest bid price wins the impression at the second highest bid price known as the “clearing price.” This is primarily because of the unknown nature of any one bidder's bid price to every other bidder's bid price for an impression at each auction (i.e., a sealed bid type of auction).

The goal of an advertiser in their online advertising campaign is to get as many hits or clicks (i.e., “conversions”) by the online users on the advertiser's ad or impression on a publisher's Web page, with these conversions ultimately resulting in a purchase of the advertiser's products or services, or some other user response or action desired by the advertiser.

However, most often this bid price determination is limited to determining a single optimal bid price for a single ad campaign and, as such, it does not determine an optimal bid price and associated ad budget allocation for multiple ads to be placed across multiple ad campaigns by a single advertiser, while simultaneously ensuring an optimal ad budget allocation for a period of time (e.g., daily) for a single ad campaign of a single advertiser.

### SUMMARY

According to one or more embodiments of the present invention, a computer-implemented method includes determining, by the processor, an optimal bid price for each one of a plurality of campaigns in each one of a plurality of online real time bidding auctions. The method also includes wherein determining, by the processor, an optimal bid price for each one of a plurality of campaigns in each one of a plurality of online real time bidding auctions includes determining, by the processor, a winning function for bids placed for campaigns in each one of a plurality of online real time bidding auctions, and determining, by the processor, a bidding function for bids placed for campaigns in each one of a plurality of online real time bidding auctions. The method also includes determining, by the processor, the optimal bid price for each one of a plurality of campaigns in each one of a plurality of online real time bidding auctions as a function of the determined winning function and the determined bidding function.

According to another embodiment of the present invention, a system includes a processor in communication with one or more types of memory, the processor configured to determine an optimal bid price for each one of a plurality of campaigns in each one of a plurality of online real time bidding auctions. The method also includes wherein when the processor is configured to determine an optimal bid price for each one of a plurality of campaigns in each one of a plurality of online real time bidding auctions, the processor is configured to determine a winning function for bids placed for campaigns in each one of a plurality of online real time bidding auctions, and to determine a bidding function for bids placed for campaigns in each one of a plurality of online real time bidding auctions. The method also includes the processor configured to determine the optimal bid price for each one of a plurality of campaigns in each one of a plurality of online real time bidding auctions as a function of the determined winning function and the determined bidding function.

According to yet another embodiment of the present invention, a computer program product includes a non-transitory storage medium readable by a processing circuit and storing instructions for execution by the processing circuit for performing a method that includes determining, by the processor, an optimal bid price for each one of a plurality of campaigns in each one of a plurality of online real time bidding auctions. The method also includes wherein determining, by the processor, an optimal bid price for each one of a plurality of campaigns in each one of a plurality of online real time bidding auctions includes determining, by the processor, a winning function for bids placed for campaigns in each one of a plurality of online real time bidding auctions, and determining, by the processor, a bidding function for bids placed for campaigns in each one of a plurality of online real time bidding auctions. The method also includes determining, by the processor, the optimal bid price for each one of a plurality of campaigns in each one of a plurality of online real time bidding auctions as a function of the determined winning function and the determined bidding function.

According to still another embodiment of the present invention, a computer-implemented method includes determining, by a processor, an optimal allocation of an advertiser's advertising budget during a certain period of time for each one of a multiple of ad campaigns of the advertiser. The method also includes determining, by the processor, an optimal pacing rate of spend of the advertiser's advertising budget during a certain period of time for each one of the multiple ad campaigns of the advertiser. The method further includes the processor determining the optimal allocation of an advertiser's advertising budget during a certain period of time for each one of a multiple of ad campaigns of the advertiser and determining an optimal pacing rate of spend of the advertiser's advertising budget during a certain period of time for each one of the multiple ad campaigns of the advertiser by the processor utilizing empirical data relating to an actual ad budget spend over a predetermined training period of time and by the processor allocating a portion of the advertiser's advertising budget to each on of a plurality of time windows based on a probability of achieving an optimal value for each of one or more parameters.

According to yet another embodiment of the present invention, a computer program product includes a non-transitory storage medium readable by a processing circuit and storing instructions for execution by the processing circuit for performing a method that includes determining, by a processor, an optimal allocation of an advertiser's advertising budget during a certain period of time for each one of a multiple of ad campaigns of the advertiser. The method also includes determining, by the processor, an optimal pacing rate of spend of the advertiser's advertising budget during a certain period of time for each one of the multiple ad campaigns of the advertiser. The method further includes the processor determining the optimal allocation of an advertiser's advertising budget during a certain period of time for each one of a multiple of ad campaigns of the advertiser and determining an optimal pacing rate of spend of the advertiser's advertising budget during a certain period of time for each one of the multiple ad campaigns of the advertiser by the processor utilizing empirical data relating to an actual ad budget spend over a predetermined training period of time and by the processor allocating a portion of the advertiser's advertising budget to each one of a plurality of time windows based on a probability of achieving an optimal value for each of one or more parameters.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein;

FIG. 4 is a block diagram of a real time bidding system including details of an advertiser in accordance with one or more embodiments of the present invention; and

FIG. 5 is a flow diagram of a method for optimizing bid prices in accordance with one or more embodiments of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

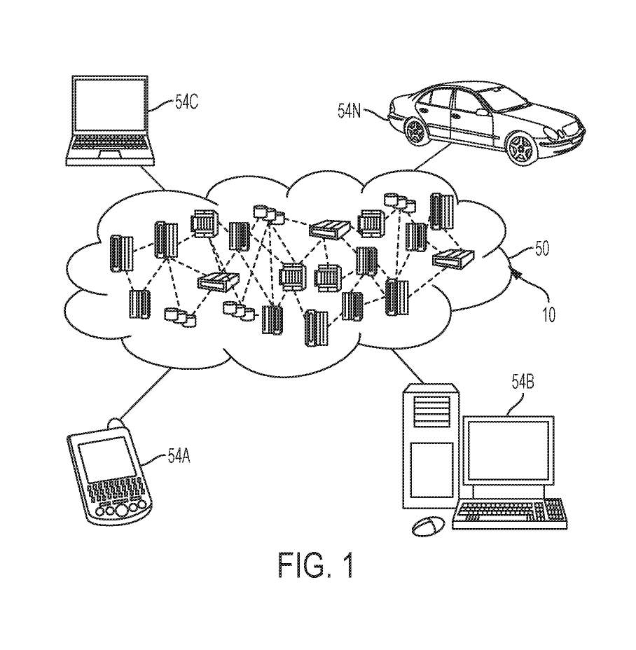

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

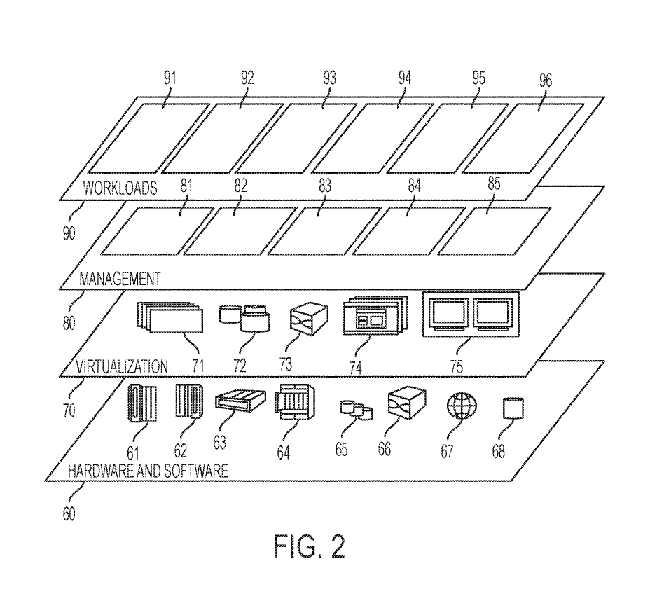

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a method 96 for optimization of bid prices and budget allocation for ad campaigns in online real time bidding environments in accordance with one or more embodiments of the present invention.

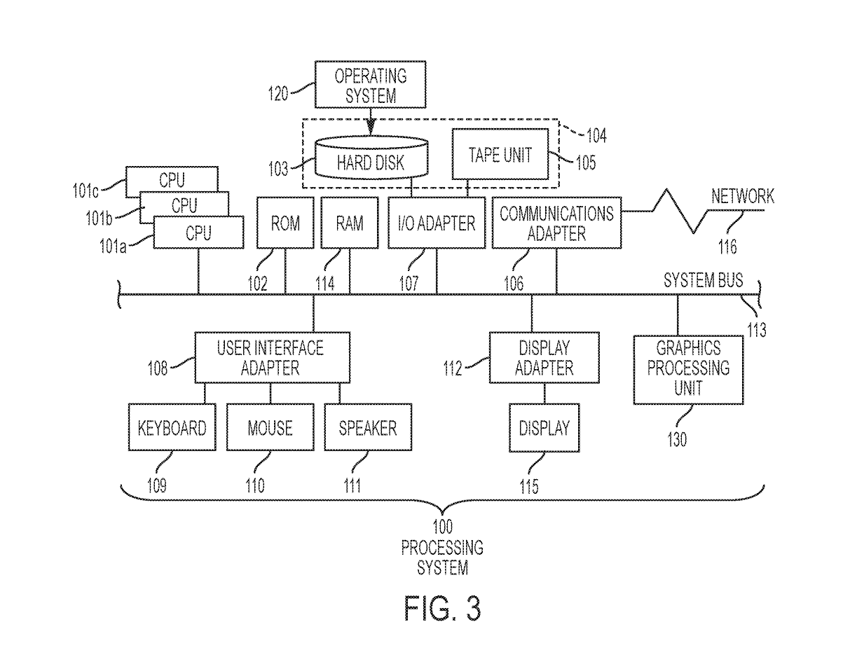

Referring to FIG. 3, there is shown a processing system 100 for implementing the teachings herein according to one or more embodiments. The system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

In accordance with one or more embodiments of the present invention, methods, systems, and computer program products are disclosed for optimizing the amount of the bid prices and the budget allocation for online Web page advertising campaigns in real time bidding environments.

One or more embodiments of the present invention allow for the determination of optimal bid prices, ad budget allocations (or re-allocations), and rate of budget spend or “pacing” for multiple ads and multiple ad campaigns of an advertiser within a period of time (e.g., daily or 24 hours) in online real time bidding environments.

Further, one or more embodiments of the present invention allow for the allocation of a daily ad budget and for the determination of ad budget spend pacing rate for an online advertiser based on a number of either linear (i.e., equal) time windows or “buckets,” or non-linear (i.e., different or unequal) time buckets, within the 24 hour daily time period. For example, linear time buckets for a 24 hour daily ad budget may each be one hour in duration, whereas for non-linear time buckets for the same 24 hour period, the first six hours of the 24 hour daily ad budget may be divided into three two-hour buckets, while the next six hours may be divided into two three-hour buckets, etc. That is, the duration in hours of the time buckets are not all the same across the entire 24 hour period. Similarly, the optimal bid prices may also be determined across linear or non-linear time buckets.

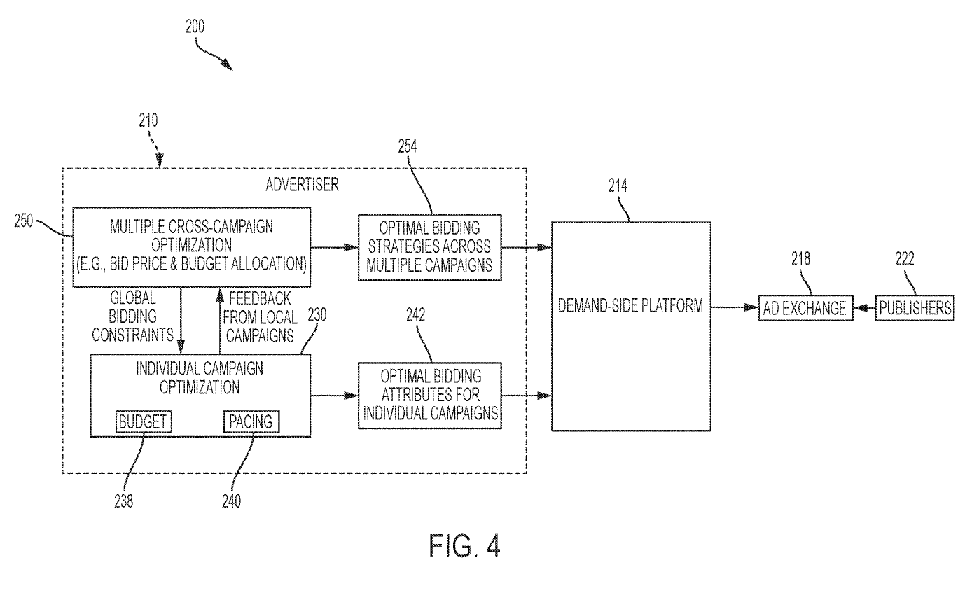

Referring now to FIG. 4, there illustrated is a block diagram of an RTB system 200 including detailed functional features of an advertiser 210 in accordance with one or more embodiments of the present invention. In exemplary embodiments, the functional features of the advertiser 210 may be implemented as software embodied in the cloud computing environment 50 of FIG. 1, or in the processing system 100 of FIG. 3, or in some other type of computing or processing environment.

Generally speaking, in an RTB system 200 such as that shown in FIG. 4, the advertiser function 210 interfaces or works with a demand-side platform (“DSP”) 214, which is a software tool that automates the buying of online ads on behalf of the advertiser 210. DSP's 214 are normally provided by third parties (e.g., The Trade Desk). The DSP 214 typically connects with an ad exchange 218, which is a software tool normally provided by a third party, that acts as an intermediary between advertisers 210 and publishers 222 to facilitate the buying and selling of online ad spaces or impressions in the fast-paced RTB auction process. The publisher 222 is the provider of a Web page with available ad space (e.g., one or more spots or slots) that the publisher 222 would like to sell each one at as high a price as possible to an advertiser 210 looking to place their ad or impression on an available slot on the publisher's Web page. Although not shown in FIG. 4, sometimes a publisher 222 may use the services of a supply-side platform (“SSP”), which is a third party intermediary, to help the publisher 222 better manage and sell its ad inventory.

It should be understood that FIG. 4 merely represents one exemplary embodiment of an RTB system 200 within which one or more detailed embodiments of an advertiser 210 may reside in or be a part of. Other embodiments of RTB systems now known or hereinafter invented may be utilized with one or more embodiments of the present invention.

In one or more embodiments of the present invention, the advertiser function 210 portion of the RTB system 200 includes a functional block of individual campaign optimization 230, whose primary functions are to determine the optimal budget allocation 238 for each individual ad campaign, and to determine the optimal pacing 240 or rate of spend of the ad budget during a certain time period for each individual ad campaign. The pacing 240 is a determined rate at which an advertiser may spend its ad budget during the course of a planning period (e.g., daily or 24 hours) such that the available ad budget is not completely spent too early in the planning period, or such that there is not relatively too much unused or unspent money left in the allocated ad budget at the end of the planning period. Other desired characteristics of the pacing rate 240 include it being changing or dynamic in nature (as opposed to flat or constant) across the 24 hour daily period, and it being relatively smooth in nature (i.e., without relatively large fluctuations during the 24 hour day). Essentially, the pacing rate 240 should strive to reach the maximum amount of desired or “target” types of online users at various times during the day. Thus, it can be seen that the budget and pacing rate are inherently intertwined in the sense that the pacing rate encompasses the budget.

An advertiser typically has multiple online ad campaigns ongoing at any one point in time. Regardless of the number of ongoing ad campaigns, the individual campaign optimization block 230 determines the optimal budget allocation 238 and the optimal pacing rate 240 for each one of the advertiser's then-current ad campaigns. The individual campaign optimization block 230 may provide its determined optimal budget allocation 238 and pacing ad budget spend rate 240 for each ad campaign as optimal bidding attributes 242 to the DSP 214.

The advertiser function 210 may also include a multiple cross-campaign optimization functional block 250, which determines the optimal bid price for each of the multiple current ad campaigns. Advertiser's goals include having the determined optimal bid price be the winning bid price. Also, after the advertiser's winning ad or impression has been placed on a publisher's Web page, the total number of conversions (i.e., hits or clicks) by the online users on the advertiser's ad or impression located on a publisher's Web page is maximized.

The cross-campaign block 250 also allocates (i.e., re-allocates) the overall ad budget of the advertiser across the multiple ad campaigns while complying with the advertiser's total ad budget constraint (i.e., maximum allowable dollar spend). The cross-campaign block 250 may provide its determined optimal bid pricing and optimal budget allocation as optimal bidding strategies across the multiple ad campaigns 254 to the DSP 214. Also, the cross-campaign block 250 may provide global bidding constraints to the individual campaign optimization block 230, while also receiving feedback from that block 230 regarding the individual (local) ad campaigns.

For the individual campaign optimization block 230, one of the functional capabilities is time-based budget allocation for each current ad campaign of the advertiser 210. This capability determines the optimal cost per click or conversion (“CPC”) function for each ad campaign. In accordance with one or more embodiments of the present invention, this may be accomplished by making changes to the budget amount for each ad campaign on an individual time bucket basis. The changes are made to the time bucket budget windows as part of a performance-based, time-of-day budget allocation strategy aimed at achieving the largest expected increase in the number of conversions and in the reduction in the CPC for each time bucket.

In accordance with one or more embodiments, a simulation-based environment may be adopted wherein the performance of some exemplary number of different time bucket definitions (e.g., four) under a performance-based strategy is tested. This strategy may employ empirical or historical data from a “training” period of time in which an ad campaign used a simple flat or constant budget spend for each 24 hour daily period of time within a larger window of time (e.g., 14 days). Also, the average daily amount of the ad budget spent may differ between days within the 14 day training period.

For example, a 24 hour daily planning or training period may be divided into four different linear (or non-linear) time bucket definitions: a first definition being 24 one hour time windows or buckets; a second definition being 12 two hour time buckets; a third definition being 8 three hour time buckets; and a fourth definition being 4 six hour time buckets. For all four of these time bucket definitions, hour one starts at midnight, although they could start at some other hour of the day. Also, a 24 hour daily period is typical in RTB environments, although not mandatory.

For simulation starting purposes, one may use a “business as usual” approach in which the daily 24 hour budget data used may be the average budget per hour actually spent in the past for each one of one or more actual ad campaigns for which empirical ad spend data is available. That is, the total ad budget spent over the course of the 14 day period may be determined and then divided by 14 to arrive at the average daily ad budget spend for each of the 14 days in that 14 day time period.

Also, the overall actual ad budget dollar amount spent for a certain 24 hour time period may be used and divided by 24 to determine the actual hourly average budget dollar amount spent during that time period. This determination may be repeated for a number of days (e.g., 14 consecutive days) for each one of multiple ad campaigns. The empirical data may also include the total number of conversions for each ad campaign as totaled over the 14 consecutive day time period. This will give the simulation the necessary starting data.

It should be noted that the simulation model of one or more embodiments of the present invention differs from the “business as usual” approach described above in that the simulation model estimates the distribution for win rate, conversion/click rate, cost, etc. Then, using a stochastic dynamic programming approach, the simulation model optimally allocates the budget available for a 24 hour time period across the linear or non-linear time buckets.

Again, the goal of the performance-based, time-of-day budget allocation strategy is achieving the largest expected increase in the number of conversions and in the reduction in the CPC for each time bucket with each of the aforementioned four different time bucket definitions. This budget allocation strategy essentially determines the optimal dollar amount to be placed in each of the time buckets within each of the four different time bucket definitions. The optimal dollar amount to be placed within each time bucket may be determined in one of a number of ways. For example, a stochastic dynamic programming equation may be used to allocate budget proportional to the expected number of clicks or conversions in each time bucket, such as Equation 1 as follows:

$${b}_{t + 1}^{p} = ( B - {\sum }_{m = 1}^{t} s ( m ) ) \frac{{p}_{t + 1} \cdot L ( t + 1 )}{{\sum }_{m = t + 1}^{T} {p}_{m} \cdot L ( m )} \qquad EQ . 1$$

Where:

B is the total campaign budget to be allocated;

bₜ₊₁ is the bid price for an ad campaign at the next time bucket t+1;

p denotes bₜ₊₁ is probabilistic—for example the click/conversion probabilities;

m is a time period index;

s(m) is budget spent in time m;

L(m) is the length of time period m; and

T is the total number of time buckets.

Thus, Equation 1 determines the optimal dollar amount to be placed into each one of the time buckets within each of the four different time bucket definitions. It does this in part using empirical data from the 14 day training period; here, the actual average campaign budget, B, for each 24 hour period within the 14 day training period. It also does this under the constraint of preserving the total ad campaign budget.

After running the simulation using Equation 1 a number of times, each bucket definition inherently results in a different budget dollar amount being allocated for each time bucket of the day. As such, it can be readily seen from the simulation results as to which time bucket definition (i.e., of the four definitions in this exemplary embodiment) was most effective at increasing the number of conversions and also in reducing the cost per click (“CPC”). That is, running of the simulation assists in determining a relatively “best” pacing rate for the ad budget spend for each ad campaign.

For the multiple cross-campaign optimization block 250, one of the functional capabilities is an optimization formulation, whose goal is to find the optimal bid price for each ad campaign, so as to maximize the total conversions across these ad campaigns, while complying with the overall total ad budget constraint of the advertiser.

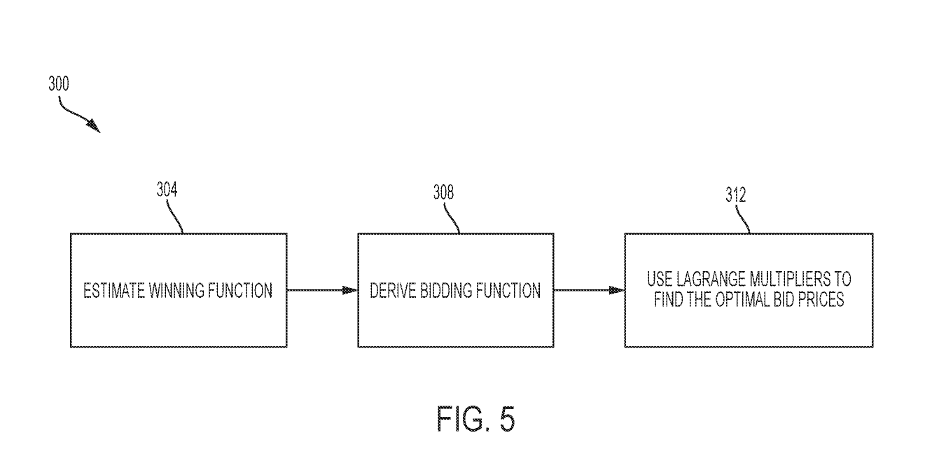

Referring also now to FIG. 5, there illustrated is a flow diagram of a method 300 for optimizing bid prices in accordance with one or more embodiments of the present invention.

In exemplary embodiments, finding the optimal bid or bidding price of each ad campaign starts with a block 304 where the winning function, w, is estimated or modeled. This operation 304 can be performed, for example, by finding the distribution of the winning bid function, w, from the bidding price, b, to the winning rate, r, using an amount of empirical data—for example two weeks' worth of actual bidding data and the corresponding winning data. The winning rate may be calculated for each bidding price from the data. Data smoothing may then be applied to smooth out any noisy data within the resulting distribution of the winning rate data. Essentially, this operation 304 estimates or determines the winning function w(bᵢ), which is used in Equations 2 and 3 hereinafter in the operations of block 308 and 312, respectively.

In exemplary embodiments, this operation 304 may also model the clearing price, p, as a function of the bidding price. The clearing price, p, is also used in Equation 3. For example, the bids may be pooled based on their bidding price over a period of time. The average clearing price, p, of all of the bids in each pool may be modeled and determined therefrom. As mentioned hereinabove, most RTB auctions operate as a “second price” type of auction where the bidder with the second highest bid price wins the impression at the clearing price. This is primarily because of the unknown nature of any one bidder's bid price to every other bidder's bid price for an impression at each auction (i.e., a sealed bid type of auction).

A block 308 may be performed in which the bidding function may be derived. By assuming that the bidding prices (bᵢ) are independent of each other, we can derive a function of the bid price, b, given a winning function wᵢ of bᵢ, and a conversion rate c. This can be carried out, for example, by using the method of Lagrange multiplier.

$$λ \times w ( {b}_{i} ) \times \frac{\partial p}{\partial {b}_{i}} = ( {c}_{i} - λ \times p ( {b}_{i} ) ) \times \frac{\partial w}{\partial {b}_{i}} \qquad EQ . 2$$

In Equation 2, λ is the Lagrange multiplier, and the other variables are defined herein below with respect to Equations 3 and 4. Equation 2 can be solved for the bidding price or function bᵢ using the determined winning function w(bᵢ) from the operation 304 and the determined average clearing price, p, also from the operation 304.

Finally, in a block 312 the optimal bid prices across all of the ad campaigns may be determined, for example, by simultaneously solving Equations 3 and 4.

$$\begin{matrix}O = {arg max}_{{b}_{i}} = {\sum }_{i = 1}^{G} {R}_{i} \times w ( {b}_{i} ) \times {c}_{i} & EQ . 3 \\ subject to \text{:} {\sum }_{i = 1}^{G} {R}_{i} \times w ( {b}_{i} ) \times p ( {b}_{i} ) \leq B & EQ . 4\end{matrix}$$

Where:

G is the total number of ad campaigns;

B is the total campaign budget to be allocated to G ad campaigns;

bᵢ is the bid price for ad campaign i as determined by the operation 308;

Rᵢ is the incoming ad request for ad campaign i;

cᵢ is the conversion rate for ad campaign i;

w is the winning function (i.e., bid price is greater than the winning rate) as determined as w(bᵢ) from the operation 304; and

p is the clearing price function (i.e., bid price is greater than the clearing price) as determined by the operation 304.

Equation 4 is the constraint of the optimization problem as set out in Equation 4. The Lagrange multiplier may be derived from Equation 4 for example, by using an amount of empirical data (e.g., 7 days' worth) to estimate or determine the optimal value for the Lagrange multiplier, λ. This optimal value for the Lagrange multiplier maximizes the total conversions across all of the ad campaigns while having the advertiser's ad budget comply with the overall budget constraint.

One or more embodiments of the present invention optimize cross-campaign budget allocation, and allocate an ad campaign's daily ad budget across multiple time buckets. This information may be used to determine bid prices. One or more embodiments also solve bid price optimization across multiple ad campaigns, they address bid price and budget within time of day time buckets or windows, and consider bid prices and budget jointly across multiple ad campaigns.

Additionally, one or more other embodiments of the present invention may take into account when determining an optimal bid price, budget allocation and pacing rate, any data regarding the online history of each online user (i.e., the user's “journey” across one or more Web pages while that user has been online currently or in the past). This data may originate from different sources, such as first party data (e.g., web performance, bids, impressions, bid wins, conversions, etc.), third party data (e.g., audiences, segments, etc.), and earned, online or social data (e.g., online presence, relevant content, audience intentions, trends, brand eminence, content effectiveness, etc.). This data gives the advertiser additional valuable information about each online user who may or may not click on an advertiser's online ad (i.e., perform a “conversion”). The advertiser can thus factor this additional information into its bid prices, budget allocation and pacing rate in an effort to better identify potential “targets” for its online ads.

Also, one or more embodiments of the present invention allow for real time bidding to be integrated as part of content marketing initiatives, and to effectively reach the global online audience through a cross platform solution to a bid price and budget allocation optimization determination problem.

Further, one or more embodiments of the present invention allow advertisers to address their relatively sophisticated ad campaign needs by optimizing bid prices and budget allocations across multiple ad strategies, ad campaigns and marketing goals.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining, by a processor, an optimal bid price for each one of a plurality of campaigns in each one of a plurality of online real time bidding auctions, wherein determining, by the processor, an optimal bid price for each one of a plurality of campaigns in each one of a plurality of online real time bidding auctions comprises:
determining, by the processor, a winning function for bids placed for campaigns in each one of a plurality of online real time bidding auctions;
determining, by the processor, a bidding function for bids placed for campaigns in each one of a plurality of online real time bidding auctions; and
determining, by the processor, the optimal bid price for each one of a plurality of campaigns in each one of a plurality of online real time bidding auctions as a function of the determined winning function and the determined bidding function.

2. The computer-implemented method of claim 1 further comprising determining, by the processor, a clearing price as a function of empirical data related to bidding prices.

3. The computer-implemented method of claim 1 wherein determining, by the processor, a winning function for bids placed for campaigns in each one of a plurality of online real time bidding auctions comprises determining, by the processor, a distribution rate of a winning bid function from a bidding price to a winning rate using an amount of empirical data.

4. The computer-implemented method of claim 1 wherein determining, by the processor, a bidding function for bids placed for campaigns in each one of a plurality of online real time bidding auctions comprises determining, by the processor, using a Lagrange multiplier to solve for the determined bidding function using a determined winning function and a determined average clearing price.

5. The computer-implemented method of claim 1 wherein determining, by the processor, the optimal bid price for each one of a plurality of campaigns in each one of a plurality of online real time bidding auctions as a function of the determined winning function and the determined bidding function comprises determining, by the processor, a solution to an optimization formulation so as to maximize a total number of advertisement conversion across all of a number of advertisement campaigns of the advertiser.

6. A system comprising:
a processor in communication with one or more types of memory, the processor configured to:
determine an optimal bid price for each one of a plurality of campaigns in each one of a plurality of online real time bidding auctions, wherein when the processor is configured to determine an optimal bid price for each one of a plurality of campaigns in each one of a plurality of online real time bidding auctions, the processor is configured to:
determine a winning function for bids placed for campaigns in each one of a plurality of online real time bidding auctions;
determine a bidding function for bids placed for campaigns in each one of a plurality of online real time bidding auctions; and
determine the optimal bid price for each one of a plurality of campaigns in each one of a plurality of online real time bidding auctions as a function of the determined winning function and the determined bidding function.

7. The system of claim 6 wherein the processor is further configured to determine a clearing price as a function of empirical data related to bidding prices.

8. The system of claim 6 wherein the processor configured to determine a winning function for bids placed for campaigns in each one of a plurality of online real time bidding auctions comprises the processor configured to a determine a distribution rate of a winning bid function from a bidding price to a winning rate using an amount of empirical data.

9. The system of claim 6 wherein the processor configured to determine a bidding function for bids placed for campaigns in each one of a plurality of online real time bidding auctions comprises the processor configured to use a Lagrange multiplier to solve for the determined bidding function using a determined winning function and a determined average clearing price.

10. The system of claim 6 wherein the processor configured to determine the optimal bid price for each one of a plurality of campaigns in each one of a plurality of online real time bidding auctions as a function of the determined winning function and the determined bidding function comprises the processor configured to determine a solution to an optimization formulation so as to maximize a total number of advertisement conversion across all of a number of advertisement campaigns of the advertiser.

11. A computer program product comprising:
a non-transitory storage medium readable by a processing circuit and storing instructions for execution by the processing circuit for performing a method comprising:
determining, by the processor, an optimal bid price for each one of a plurality of campaigns in each one of a plurality of online real time bidding auctions, wherein determining, by the processor, an optimal bid price for each one of a plurality of campaigns in each one of a plurality of online real time bidding auctions comprises:
determining, by the processor, a winning function for bids placed for campaigns in each one of a plurality of online real time bidding auctions;
determining, by the processor, a bidding function for bids placed for campaigns in each one of a plurality of online real time bidding auctions; and
determining, by the processor, the optimal bid price for each one of a plurality of campaigns in each one of a plurality of online real time bidding auctions as a function of the determined winning function and the determined bidding function.

12. The computer program product of claim 11 wherein further comprising determining, by the processor, a clearing price as a function of empirical data related to bidding prices.

13. The computer program product of claim 11 wherein determining, by the processor, a winning function for bids placed for campaigns in each one of a plurality of online real time bidding auctions comprises determining, by the processor, a distribution rate of a winning bid function from a bidding price to a winning rate using an amount of empirical data.

14. The computer program product of claim 11 wherein determining, by the processor, a bidding function for bids placed for campaigns in each one of a plurality of online real time bidding auctions comprises determining, by the processor, using a Lagrange multiplier to solve for the determined bidding function using a determined winning function and a determined average clearing price.

15. The computer program product of claim 11 wherein determining, by the processor, the optimal bid price for each one of a plurality of campaigns in each one of a plurality of online real time bidding auctions as a function of the determined winning function and the determined bidding function comprises determining, by the processor, a solution to an optimization formulation so as to maximize a total number of advertisement conversion across all of a number of advertisement campaigns of the advertiser.

16. A computer-implemented method comprising:
determining, by a processor, an optimal allocation of an advertiser's advertising budget during a certain period of time for each one of a multiple of ad campaigns of the advertiser; and
determining, by the processor, an optimal pacing rate of spend of the advertiser's advertising budget during a certain period of time for each one of the multiple ad campaigns of the advertiser;
wherein the processor determines the optimal allocation of an advertiser's advertising budget during a certain period of time for each one of a multiple of ad campaigns of the advertiser and determines an optimal pacing rate of spend of the advertiser's advertising budget during a certain period of time for each one of the multiple ad campaigns of the advertiser by the processor utilizing empirical data relating to an actual ad budget spend over a predetermined training period of time and by the processor allocating a portion of the advertiser's advertising budget to each one of a plurality of time windows based on a probability of achieving an optimal value for each of one or more parameters.

17. The computer-implemented method of claim 16 wherein the probability of achieving an optimal value for each of one or more parameters is determined by the processor based on a stochastic dynamic programming equation.

18. The computer-implemented method of claim 16 wherein the one or more parameters includes one of a largest estimated increase in a number of conversions by a user and a largest estimated reduction in a cost per click for each click on an ad of the advertiser on a Web page.

19. The computer-implemented method of claim 16 wherein the predetermined training period of time comprises a daily time period of 24 hours, and wherein each one of a plurality of time windows comprises one of an equal or unequal portion of the daily time period.

20. The computer-implemented method of claim 16 wherein the processor allocating a portion of the advertiser's advertising budget to each one of a plurality of time windows comprises the processor dividing the predetermined training period of time into a multiple of different amounts of time for each one of the plurality of time windows, the processor allocating a portion of the advertiser's advertising budget to each one of the plurality of time windows within each one of the multiple amounts of time, and the processor determining a one of the multiple amounts of time for which the probability of achieving an optimal value for each of one or more parameters is the greatest.

21. A computer program product comprising:
a non-transitory storage medium readable by a processing circuit and storing instructions for execution by the processing circuit for performing a method comprising:
determining, by a processor, an optimal allocation of an advertiser's advertising budget during a certain period of time for each one of a multiple of ad campaigns of the advertiser; and
determining, by the processor, an optimal pacing rate of spend of the advertiser's advertising budget during a certain period of time for each one of the multiple ad campaigns of the advertiser;
wherein the processor determines the optimal allocation of an advertiser's advertising budget during a certain period of time for each one of a multiple of ad campaigns of the advertiser and determines an optimal pacing rate of spend of the advertiser's advertising budget during a certain period of time for each one of the multiple ad campaigns of the advertiser by the processor utilizing empirical data relating to an actual ad budget spend over a predetermined training period of time and by the processor allocating a portion of the advertiser's advertising budget to each one of a plurality of time windows based on a probability of achieving an optimal value for each of one or more parameters.

22. The computer program product of claim 21 wherein the probability of achieving an optimal value for each of one or more parameters is determined by the processor based on a stochastic dynamic programming equation.

23. The computer program product of claim 21 wherein the one or more parameters includes one of a largest estimated increase in a number of conversions by a user and a largest estimated reduction in a cost per click for each click on an ad of the advertiser on a Web page.

24. The computer program product of claim 21 wherein the predetermined training period of time comprises a daily time period of 24 hours, and wherein each one of a plurality of time windows comprises one of an equal or unequal portion of the daily time period.

25. The computer program product of claim 21 wherein the processor allocating a portion of the advertiser's advertising budget to each one of a plurality of time windows comprises the processor dividing the predetermined training period of time into a multiple of different amounts of time for each one of the plurality of time windows, the processor allocating a portion of the advertiser's advertising budget to each one of the plurality of time windows within each one of the multiple amounts of time, and the processor determining a one of the multiple amounts of time for which the probability of achieving an optimal value for each of one or more parameters is the greatest.
